(19) United States
(12) Patent Application Publication
(10) Pub. No.: US 2004/0243940 A1
(43) Pub. Date: Dec. 2, 2004

(54) Display apparatus and method of adjusting display settings thereof

(75) Inventors: Kyung-Shik Lee, Yongin-City (KR); Mi-Sook Jang, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-si (KR)

(21) Appl. No.: 10/824,445

(22) Filed: Apr. 15, 2004

(30) Foreign Application Priority Data
May 31, 2003 (JP) 2003-35161

(51) Int. Cl. G09G 5/00

(52) U.S. Cl. 715/744; 715/747

(57) ABSTRACT

A method to provide a convenient user interface to change a display setting of a picture area of a display apparatus, which is communicated with an external device, the method including: displaying a main window including a step start button to initiate a sequence of at least first and second display setting adjustment windows in which first and second display setting adjustments are made; displaying sequentially the display setting adjustment windows corresponding to a selection of the step start button; adjusting the display setting through the displayed display setting adjustment windows; issuing a command from the external device in correspondence to adjusting the displayed display setting adjustment windows; and setting the display setting in correspondence to the command. With this configuration, the present invention provides a convenient user interface to adjust a plurality of display settings of a picture area.

### CROSS-REFERENCE TO RELATED APPLICATIONS

This application claims the benefit of Korean Patent Application No. 2003-35161, filed May 31, 2003, in the Korean Intellectual Property Office, the disclosure of which is incorporated herein by reference.

### BACKGROUND OF THE INVENTION

1. Field of the Invention

The present invention relates to a display apparatus and a method of adjusting display settings thereof, and more particularly, to a display apparatus and a method of adjusting display settings thereof, which provides a convenient user interface to adjust a plurality of display settings of a picture area.

2. Description of the Related Art

A display apparatus receives horizontal/vertical synchronous signals and RGB (red, green, blue) signals from a graphic controller of a computer, and displays a picture.

A conventional display apparatus 920, as shown in FIGS. 1 and 2, comprises a connector 921 such as a D-sub connector receiving analog RGB signals and horizontal/vertical synchronous signals from a graphic controller of a computer; an A/D converter 923 converting the analog RGB signals into digital signals; a scaler 924 fitting the digitalized horizontal/vertical synchronous signals and the digitalized RGB signals from the A/D converter 923 to the size of an LCD (liquid crystal display) panel 926, and transmitting them to a panel driving part 925; the panel driving part 925 driving the LCD panel 926 to operate; a backlight 928 adjusting the brightness of the LCD panel 926; a microprocessor 921 controlling the foregoing components; and a power supply 927 supplying electric power to the foregoing components including the backlight 928 according to control of the microprocessor 921.

Further, the conventional display apparatus 920 comprises an OSD (on screen display) generator 929 generating an OSD signal, and an OSD control part 930 generating a key signal. The OSD control part 930 includes an OSD button 932 placed in the front of the display apparatus 920, and a key signal generator 931 generating a key signal when the OSD button 932 is pressed. Therefore, when a user presses the OSD button 932, the key signal generator 931 transmits the key signal to the microprocessor 921 in response to the pressed OSD button 932, and the microprocessor 921 controls the OSD generator 929 according to the key signal transmitted from the key generator 931, thereby activating an OSD menu 933 on the LCD panel 926. As described above, the conventional display apparatus 920 employs the OSD generator 929 and the OSD control part 930 to adjust display settings such as the size, the position, the contrast, the color temperature, the resolution, etc. of a picture area.

However, the conventional method of adjusting the display settings using the OSD generator 929 and the OSD control part 930 of the display apparatus 920 has the following problems.

First, the display apparatus 920 additionally needs the OSD generator 929, the OSD control part 930, etc. to adjust the display settings of the picture area.

Second, the display apparatus 920 should separately have an EEPROM (electrically erasable programmable read-only memory) stored with data and a program associated with items of the OSD menu 933, or should have a memory having more large storage capacity.

Third, there is a limit to the storage capacity of the memory included in the display apparatus 920, and therefore the size of the data or the program associated with the items of the OSD menu 933 is limited to the storage capacity of the memory. This may make the OSD menu 933 short, that is, all items for the display settings are not sufficiently displayed. Therefore, there is separately required an OSD manual giving instructions as to adjusting the display settings through the OSD menu 933. Further, it is inconvenient to refer to the OSD manual to adjust the display settings.

Fourth, because the front of the display apparatus 920 has a limited surface area, the OSD buttons 932 placed in the front of the display apparatus 920 is limited in number, that is, it is impossible to provide various OSD buttons 932. Therefore, a user has to press the same OSD button 932 repeatedly to adjust the display settings, which is inconvenient.

Consequently, the conventional display apparatus 920 has the OSD generator 929, the OSD control part 930, etc., but does not provide a convenient user interface to adjust the display settings of the picture area.

### SUMMARY OF THE INVENTION

Accordingly, an aspect of the present invention provides a convenient user interface to adjust a plurality of display settings of a picture area.

The foregoing and/or other aspects of the present invention are achieved by providing a method to provide a convenient user interface to change a display setting of a picture area of a display apparatus, which communicates with an external device, the method comprising: displaying a main window including a step start button to initiate a sequence of at least first and second display setting adjustment windows in which first and second display setting adjustments are made; displaying sequentially the display setting adjustment windows corresponding to a selection of the step start button; adjusting the display setting through the displayed display setting adjustment windows; issuing a command from the external device in correspondence to adjusting the displayed display setting adjustment windows; and setting the display setting in correspondence to the command.

According to another aspect of the invention, the main window includes a menu button to separately adjust the display settings.

According to another aspect of the invention, the display setting adjustments are selected from the following: a picture position adjustment; a color temperature adjustment; a resolution adjustment; clock and phase adjustments; a contrast adjustment; and a brightness adjustment.

According to another aspect of the invention, a last display setting adjustment window in the sequence includes a button to open an adjustment save window to save adjusted display settings.

According to another aspect of the invention, the method further comprises saving the adjusted display settings as a file through the adjustment save window.

According to another aspect of the invention, the method further comprises opening the file; adjusting a display setting on the basis of the saved adjusted display setting in the opened file.

According to another aspect of the invention, at least one of the display setting adjustment windows comprise an undo button to undo the display setting adjustment.

According to another aspect of the invention, at least one of the display setting adjustment windows comprise a reset button to return the display setting to a default setting.

According to another aspect of the invention, the menu button is plural in number and comprises: a display button corresponding to a first setting group including a resolution setting, a brightness setting, a contrast setting, and a clock and phase setting; a geometry button corresponding to a second setting group including a position setting; and a color button corresponding to a third setting group including a calibration setting, and a color temperature setting, wherein when each menu button is selected, a window to adjust the display setting belonging to the corresponding setting group is opened.

According to another aspect of the invention, when the display button is selected, a display adjusting window is opened, the display adjusting window comprising: a resolution button corresponding to the resolution setting; a brightness button corresponding to the brightness setting; a contrast button corresponding to the contrast setting; and a picture setup button corresponding to the clock and phase setting, is opened.

According to another aspect of the invention, when one of the buttons is selected, an adjusting window, in which a display setting adjustment corresponding to the selected button are made, is opened.

According to another aspect of the invention, the adjusting window comprises a pattern activating button to open a pattern window having a image changed as the display setting adjustment are made in the adjusting window.

According to another aspect of the invention, the adjusting window comprises: an undo button to undo the display setting adjustment; a reset button to return the display setting to a default setting; and an animation window to show an animation of the display setting adjustment.

According to another aspect of the invention, when the geometry button is selected, a geometry setting window, including a position button corresponding to the second setting group is opened.

According to another aspect of the invention, the geometry setting window comprises a pattern activating button to open a pattern window having a picture changed as the display setting adjustment are made in the adjusting window.

According to another aspect of the invention, the adjusting window comprises: an undo button to undo a position adjustment; a reset button to return a position setting to a default setting; and an animation window to show an animation of a position adjustment.

According to another aspect of the invention, when the color button is selected a color adjusting window, including a calibration button corresponding to a calibration setting and a color temperature button corresponding to a color temperature of the picture displayed by the display apparatus, is opened.

According to another aspect of the invention, when a user selects the color temperature button, a color temperature adjusting window, in which a color temperature of the picture displayed by the display apparatus is adjusted, is opened.

According to another aspect of the invention, the color temperature adjusting window comprises a pattern activating button, wherein when the pattern activating button is selected, a color temperature pattern window, having a picture with a color temperature that is changed as the color temperature is adjusted in the color temperature adjusting window, is opened.

According to another aspect of the invention, the color temperature adjusting window further comprises: an undo button to undo a color temperature adjustment; an optimizing window to display an optimized color temperature setting of the picture area; and an animation window to show an animation of a color temperature adjustment.

According to another aspect of the invention, the menu further comprises: an option button to open an option adjusting window having a magic bright button and a preferences button; a support button to open a support adjusting window having an upgrade button, a technical button, an asset ID button, and a version button.

According to another aspect of the invention, the foregoing and/or other aspects may be also achieved by providing a display apparatus receiving a video signal from a external device and displaying a image corresponding to the video signal, comprising: a interface to communicate with the external device; and a microprocessor to display a main window including a step start button to initiate a sequence of at least first and second display setting adjustment windows in which first and second display setting adjustments are made, based on a video signal inputted from the external device, and to adjust a display setting of the display based on a command inputted from the external device through the interface in correspondence to adjusting the displayed display setting adjustment windows.

According to another aspect of the invention, the display further comprises an A/D converter converting the video signal into a digital signal, a scalar fitting the digitalized signal to the size of an LCD panel and transmitting the digitalized signal to a panel driving part operating the LCD panel; a backlight; and a power supply supplying power according to the microprocessor.

According to another aspect of the invention, the external device comprises a computer including: a graphic controller connected to the interface; and a stored display setting program to provide the main window, to issue the command; wherein the display setting program transmits the command and a programming signal to provide the main window to the graphic controller which converts the programming signal into a video signal, and the graphic controller transmits the converted video signal and the command to the display apparatus through the interface.

According to another aspect of the invention, the microprocessor controls the A/D converter, the scalar, and the panel driving part according to the command from the graphic controller to activate the method.

According to another aspect of the invention, when a user selects an item through the method with a input unit, the display setting program issues a corresponding command to the graphic controller to adjust a corresponding display setting.

According to another aspect of the invention, the interface employs a Display Data Channel Common Interface (DDC-CI) including a signal line and signal sequence such that the external device reads data from the display apparatus through the DDC-CI and the command from the display setting program is transmitted to the display through the DDC-CI.

According to another aspect of the invention, the interface employs a Universal Serial Bus (USB).

According to still another aspect of the present invention, the foregoing and other aspects may be also achieved by providing a machine readable storage controlling a display apparatus to change a display setting of a picture area, which communicates with an external device, according to a method, the method comprising: displaying a main window including a step start button to initiate a sequence of at least first and second display setting adjustment windows in which first and second display setting adjustments are made; displaying sequentially the display setting adjustment windows corresponding to a selection of the step start button; adjusting the display setting through the displayed display setting adjustment windows; issuing a command from the external device in correspondence to adjusting the displayed display setting adjustment windows; and setting the display setting in correspondence to the command.

According to another aspect of the invention, the main window includes a menu button to separately adjust the display settings.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a front view of a conventional display apparatus;

FIG. 2 is a control block diagram of the conventional display apparatus;

FIG. 3 is a control block diagram of a computer system using a display apparatus according to an embodiment of the present invention;

FIGS. 4 through 9 illustrate display setting windows to sequentially adjust a plurality of display setting values in a method adjusting display settings of the display apparatus according to an embodiment of the present invention;

FIGS. 10 through 17 illustrate display adjusting windows to individually adjust the plurality of display setting values in the method adjusting the display settings of the display apparatus according to embodiments of the present invention;

FIG. 18 illustrates a magic bright setting window in the method adjusting the display settings of the display apparatus according to an embodiment of the present invention;

FIG. 19 illustrates a preferences setting window in the method adjusting the display settings of the display apparatus according to an embodiment of the present invention;

FIG. 20 illustrates an upgrading window in the method adjusting the display settings of the display apparatus according to an embodiment of the present invention;

FIG. 21 illustrates a technical supporting window in the method adjusting the display settings of the display apparatus according to an embodiment of the present invention;

FIG. 22 illustrates a display apparatus information window in the method adjusting the display settings of the display apparatus according to an embodiment of the present invention; and

FIG. 23 illustrates a version information window in the method adjusting the display settings of the display apparatus according to an embodiment of the present invention.

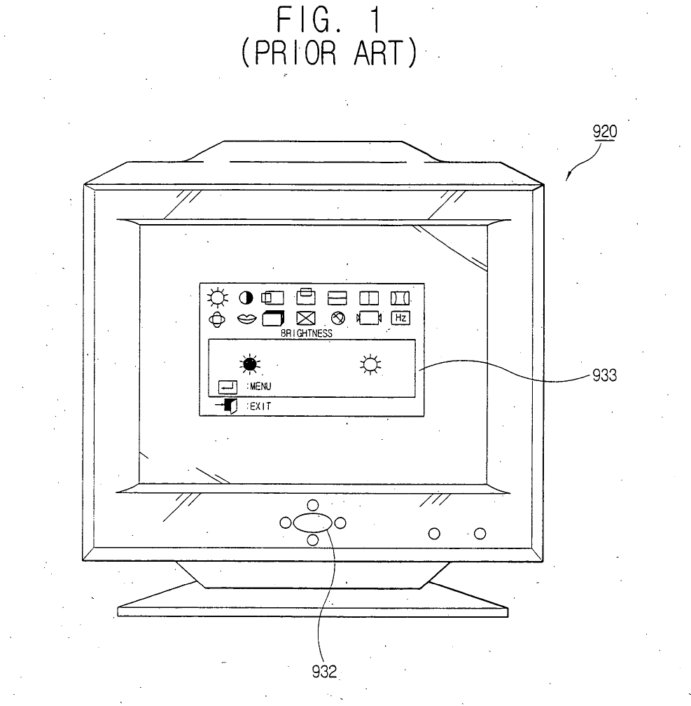

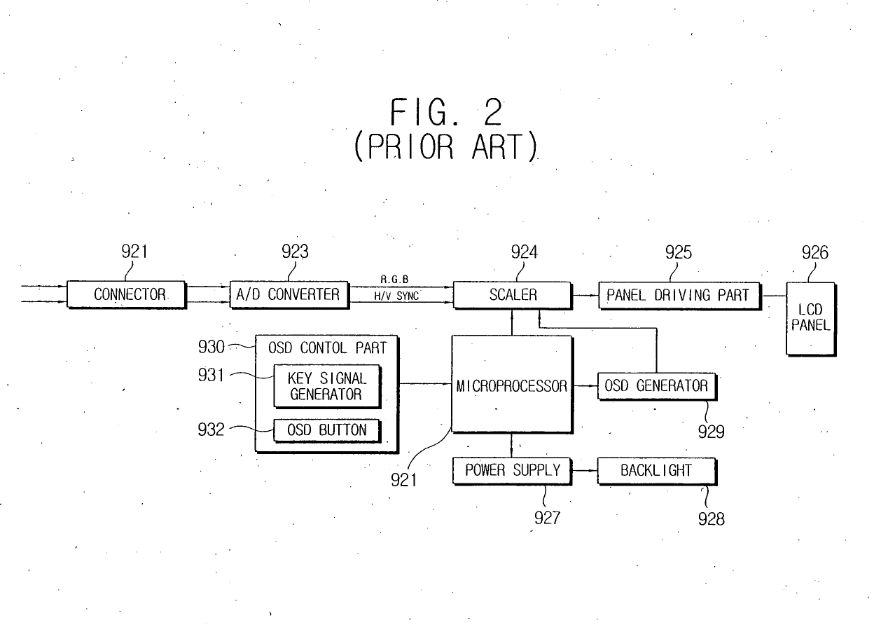

### DETAILED DESCRIPTION OF THE PREFERRED EMBODIMENTS

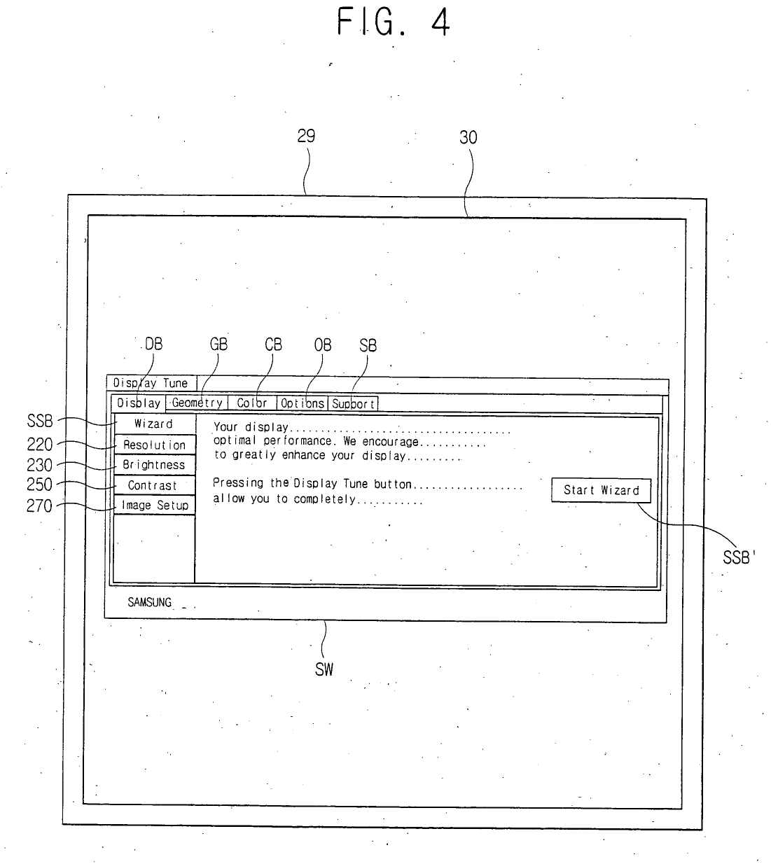

Reference will now be made in detail to the embodiments of the present invention, examples of which are illustrated in the accompanying drawings, wherein like reference numerals refer to like elements throughout. The embodiments are described below in order to explain the present invention by referring to the figures. Hereinafter, the whole LCD panel will be called a screen, and an area of the screen on which a picture is displayed will be called a picture area. In FIGS. 4 through 23, the screen picture is smaller than the screen by way of example.

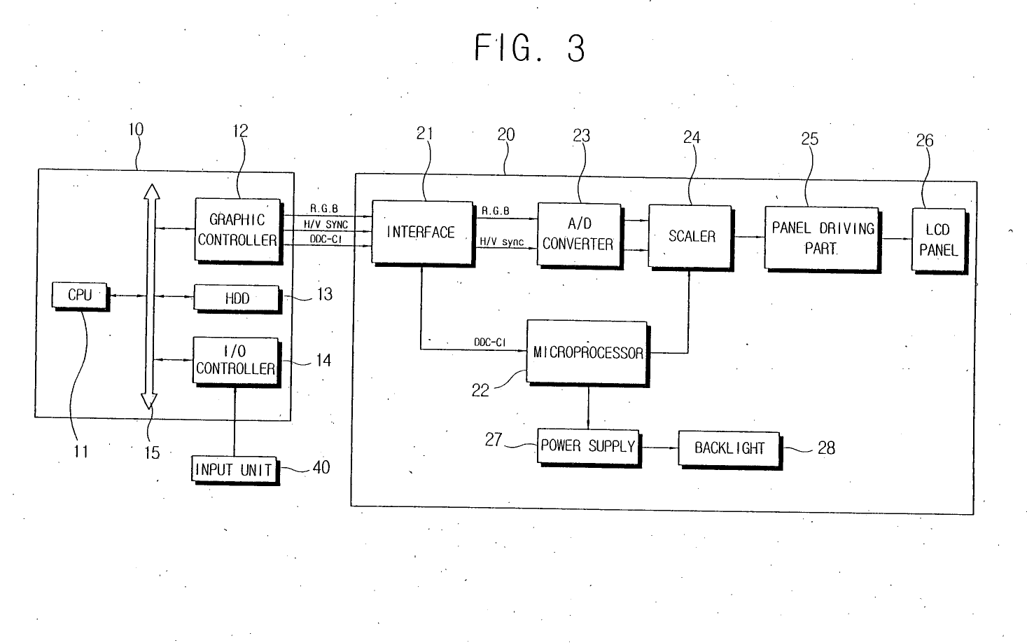

As shown in FIG. 3, a computer system according to the present invention comprises a display apparatus 20 forming a picture area, a computer 10 transmitting a video signal to the display apparatus 20, and an input unit 40 such as a keyboard, a mouse, etc.

The display apparatus 20 comprises an interface 21 receiving a video signal such as RGB signals, horizontal/vertical synchronous signals, etc., from a graphic controller 12 of the computer 10; an A/D converter 23 converting the horizontal/vertical synchronous signals and the RGB signals into digital signals; a scaler 24 fitting the digitalized horizontal/vertical synchronous signals and the digitalized RGB signals from the A/D converter 23 to the size of an LCD panel 26, and transmitting them to a panel driving part 25; the panel driving part 25 driving the LCD panel 26 to operate; a backlight 28 adjusting the brightness of the LCD panel 26; a microprocessor 22 controlling the foregoing components; and a power supply 27 supplying electric power to the foregoing components including the backlight 28 according to control of the microprocessor 22.

The computer 10 comprises a central processing unit (CPU) 11, the graphic controller 12 outputting the video signal such as the RGB signals, the horizontal/vertical synchronous signals, etc., to the display apparatus 20, an input/output (I/O) controller 14 connected to the input unit 40 and processing an input signal from the input unit 40, a hard disk drive 13 stored with an operating system (OS) and a plurality of programs based on the OS, and a system bus 15 electrically connecting the foregoing components.

The hard disk drive 13 included in the computer 10 stores a display setting program to provide an interface window allowing a user to adjust display settings of the picture area and to issue a command that the display settings of the picture area are adjusted according to the input signal through the interface window. The display setting program transmits a predetermined programming signal to the graphic controller 12 so as to provide the interface window, and the graphic controller 12 converts the received programming signal into the video signal and transmits the video signal to the display apparatus 20. Then, the microprocessor 22 of the display apparatus 20 controls the AID converter 23, the scaler 24, the panel driving part 25 according to the video signal from the graphic controller 12, thereby activating the interface window on the LCD panel 26. On the other hand, when a user selects items through the interface window with the input unit 40 such as the keyboard, the mouse, etc., the display setting program issues the command to the graphic controller 12 so as to adjust the display settings of the picture area, and then the graphic controller 12 transmits the command to the display apparatus 20. Here, the command issued from the graphic controller 12 to the interface 21 is transmitted to the microprocessor 22, and the microprocessor 22 adjusts the display settings of the picture area on the basis of the command.

The display apparatus 20 according to an embodiment of the present invention is connected to the computer 10, and two-way communication is possible between the display apparatus 20 and the computer 10. In this embodiment, the interface 21 of the display apparatus 20 connected to the computer 10 employs a DDC-CI (display data channel common interface) by way of example. However, it should be appreciated that the present invention is applicable to any two-way communication interface such as a USB (universal serial bus) interface. Here, the DDC-CI is a standard interface established by VESA (video electronics standards association), through which the computer recognizes a device when the device plugs into the computer 10, i.e., PNP (plug and play). The DDC-CI defines a signal line and signal sequence of when data flows between the display apparatus 20 and the computer 10. Concretely, when the display apparatus 20 plugs into the computer 10, the computer 10 reads data of the PNP, e.g., EDID (extended display identification) from the display apparatus 20 through the DDC-CI. Further, the command from the display setting program is transmitted to the display apparatus 20 through the DDC-CI.

On the other hand, the display settings of the picture area of the display apparatus 20 include position setting, color temperature setting, resolution setting, clock/phase setting, contrast setting, and brightness setting.

The position setting allows the position of the picture area of the display apparatus 20 to be adjusted. The color temperature setting, the resolution setting, the clock/phase setting, the contrast setting, and the brightness setting allow the color temperature, the resolution, the clock/phase, the contrast, the brightness of a picture displayed on the picture area to be adjusted, respectively. The microprocessor 22 controls the scaler 24 on the basis of a position setting value, a color temperature setting value, a resolution setting value, a clock/phase setting value, and a contrast setting value stored in a memory such as an EEPROM, and controls the backlight 28 on the basis of a brightness setting value stored in the memory, thereby adjusting the picture displayed on the picture area. In the display apparatus 20, the display settings values stored in the memory are changed in response to the command issued from the display setting program.

With this configuration, the method of adjusting the display settings of the display apparatus according to the present invention will be described hereinbelow with reference to FIGS. 4 through 23.

First, the display apparatus 20 is connected to the computer 10 through the DDC-CI. When a user executes the display setting program included on the computer 10, the display setting program transmits a main window activating signal to the graphic controller 12. The graphic controller 12 converts the main window activating signal into a main window video signal and transmits the main window video signal to the display apparatus 20. Then, the microprocessor 22 of the display apparatus 20 controls the scaler 24, the backlight 28, and the panel driving part 25 to display the main window “SW” based on the main window video signal according to the display setting values stored in the memory. Hereinafter, a process of displaying the interface window by the microprocessor 22 with the video signal generated from the display setting program according to user's selection is the same as the above process, and repetitive descriptions will be avoided as necessary.

Referring to FIG. 4, the main window “SW” displayed on the display apparatus 20 according to the present invention comprises a step start button “SSB” and menu buttons “DB, GB, CB”. The step start button “SSB” is included to adjust the plurality of display settings sequentially, and the menu buttons “DB, GB, CB” are included to adjust the individual display setting according to the user's selection. In this embodiment, the display setting program shown in FIG. 4 displays the main window “SW” on which a display button “DB” is activated among the menu buttons “DB, GB, CB” by way of example. However, the main window “SW” having the step start button “SSB” and the menu buttons “DB, GB, CB” can be displayed without activating the step start button “SSB” and the menu buttons “DB, GB, CB”.

First, the process of sequentially adjusting the plurality of display settings as a user selects the step start button “SSB” will be described hereinbelow. Here, the main window “SW” shown in FIG. 4 further comprises a step start button “SSB'” to start the sequential adjustment of the display settings.

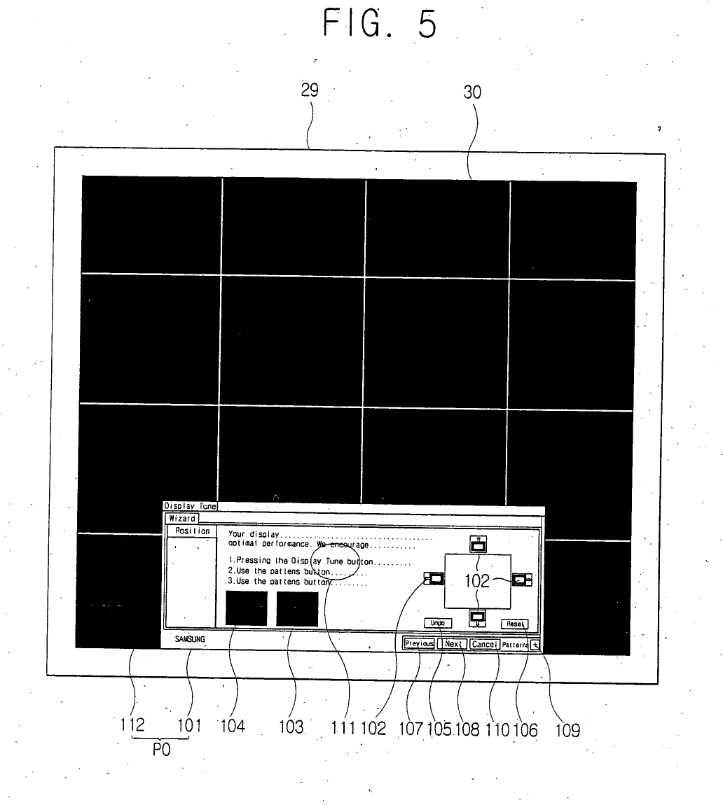

When a user selects the step start button “SSB'”, a position setting window “PO” of the position setting is opened as shown in FIG. 5. The position setting window “PO” includes a position adjusting window 101 having four position adjusting buttons 102 to control the picture area to move in up, down, left and right directions on the screen, comments 111, and a position pattern window 112 occupying the picture area except the area occupied with the position adjusting window 101. Here, when a user selects the position adjusting button 102 included on the position adjusting window 101, the display setting program issues the command corresponding to the selected position adjusting button 102 to the microprocessor 22 through the DDC-CI interface, and the microprocessor 22 controls the picture area to move in the up, down, left and right directions on the screen in correspondence to the command received from the display setting program. At this time, the position pattern window 112 (i.e., the picture area except the area occupied with the position adjusting window 101) moves in up, down, left and right directions corresponding to the position adjustment, thereby allowing a user to see the position of the picture area with naked eyes.

Further, the position adjusting window 101 includes an undo button 105. When a user selects the undo button 105, the display setting program issues the command corresponding to the selected undo button 105, and the microprocessor 22 receives the command from the display setting program through the DDC-CI, thereby undoing the position adjustment of before the position of the picture area is adjusted.

Further, the position adjusting window 101 includes a reset button 106. When the reset button 106 is selected, the position setting value is returned to a default value. That is, when a user selects the reset button 106, the display setting program issues the command corresponding to the selected reset button 106, and the microprocessor 22 receives the command from the display setting program through the DDC-CI, thereby controlling the scaler 24 to adjust the position of the picture area relative to the screen on the basis of the default value stored in the memory.

Further, the position adjusting window 101 includes an optimizing window 103 to show an optimized position according to the position adjustment. The optimizing window 103 displays a screen block corresponding to the screen and a picture block corresponding to the position pattern window 112, thereby allowing a user to get the optimized position of the picture area relative to the screen.

Further, the position adjusting window 101 includes an animation window 104 to show a position change of the position pattern window 112 as an animation corresponding to selecting the position adjusting button 102. In this embodiment, the animation window 104 is adjacent to the optimizing window 103, so that a user can see both the position change and the optimizing position of the position pattern window 112.

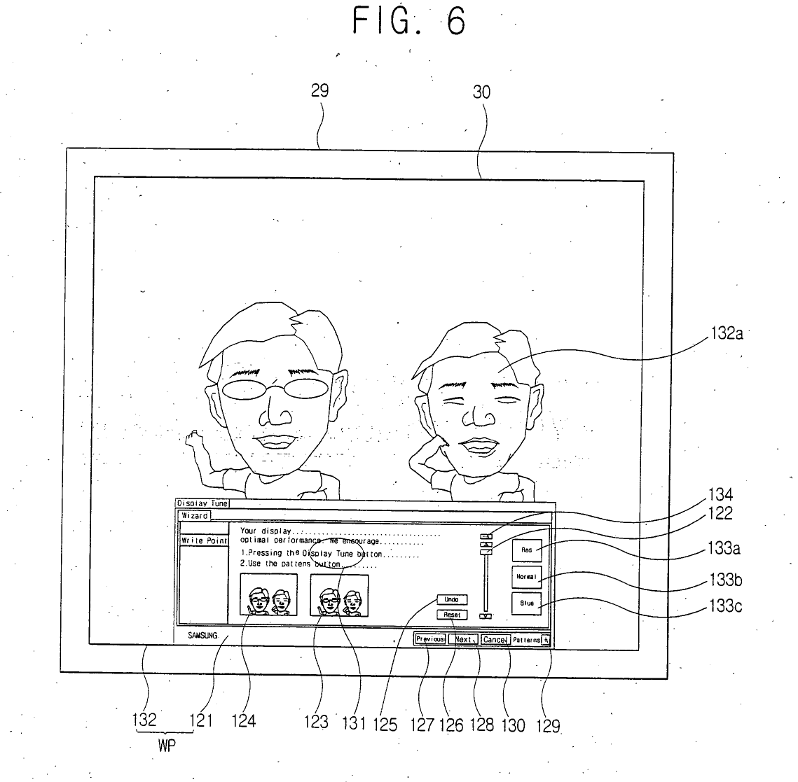

Further, the position adjusting window 101 includes a previous button 107 to return to the previous setting window, e.g., the main window “SW” previous to the position setting window “PO”, and a next button 108 to move to the next setting window, e.g., a color temperature setting window “WP” as shown in FIG. 6. Here, when the next button 108 is selected, the changed position setting value based on the position adjustment due to the user's selection is stored in memory.

Second, when a user selects the next button 108 of the position adjusting window 101 after the position adjustment is completed, the color temperature setting window “WP” is opened as shown in FIG. 6. The color temperature setting window “WP” includes a color temperature adjusting window 121 having a color temperature drag bar 122 to be dragged on the color temperature adjusting window 121 so as to adjust the color temperature setting value, comments 131, and a color temperature pattern window 132 having a predetermined picture 132a of which the color temperature is changed as the color temperature drag bar 122 of the color temperature adjusting window 121 is dragged. Here, when a user drags the color temperature drag bar 122, the display setting program issues the command corresponding to the dragged color temperature drag bar 122 to the microprocessor 22 through the DDC-CI, and the microprocessor 22 controls the scaler 24 to adjust the color temperature of the picture 132a displayed on the picture area in correspondence to the received command. At this time, the color temperature pattern window 132 displays the picture 132a based on the color temperature adjustment corresponding to the dragged color temperature drag bar 122.

Further, the color temperature adjusting window 121 includes a color temperature level block 134 to represent the color temperature setting value corresponding to the dragged color temperature drag bar 122 as a numerical value. In an embodiment of the invention, the color temperature level block 134 is adjacent to the color temperature drag bar 132.

Further, the color temperature adjusting window 121 includes a red button 133a to increase a red color temperature setting value, a blue button 133c to increase a blue color temperature setting value, and a normal button 133b to adjust the color temperature setting value to mediate between the red color temperature setting value and the blue color temperature setting value. When a user selects the red button 133a, the color temperature of the picture displayed on the picture area is increased in red. When a user selects the blue button 133c, the color temperature of the picture displayed on the picture area is increased in blue. When a user selects the normal button 133b, the color temperature of the picture displayed on the picture area mediates between red and blue.

The color temperature adjusting window 121, in an embodiment of the invention, includes an undo button 125, a reset button 126, an optimizing window 123, an animation window 124, a previous button 127 and a next button 128 which correspond to the undo button 105, the reset button 106, the optimizing window 103, the animation window 104, the previous button 107 and the next button 108 included in the position adjusting window 101, respectively. Similarly, the undo button 125, the reset button 126, the optimizing window 123, the animation window 124, the previous button 127 and the next button 128 included in the color temperature adjusting window 121 are identical with those of the position adjusting window 101 in the disposition, the display and the operation, so that repetitive descriptions will be avoided.

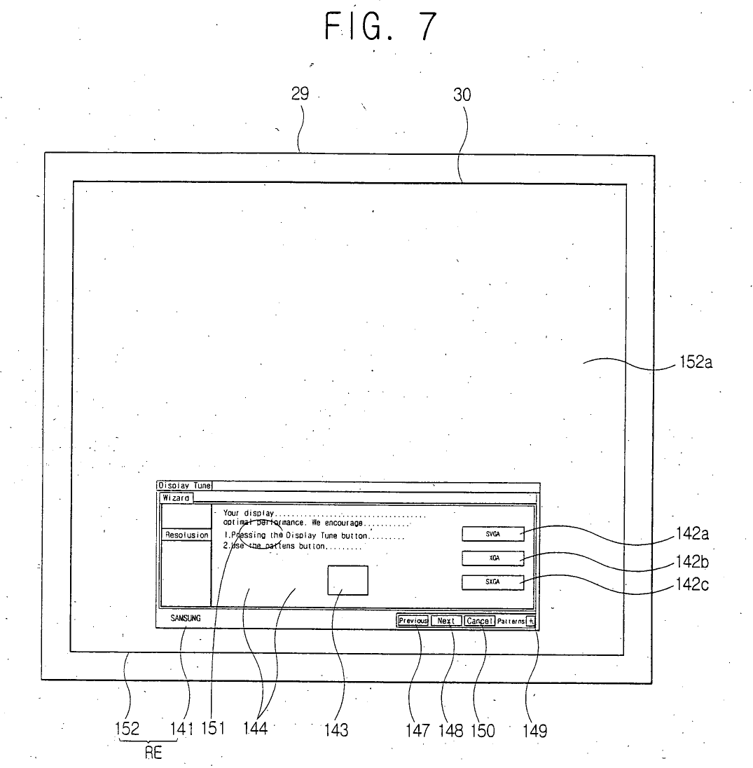

Third, when a user selects the next button 128 of the color temperature adjusting window 121 after the color temperature adjustment is completed, a resolution setting window “RE” is opened as shown in FIG. 7. The resolution setting window “RE” includes a resolution adjusting window 141 having a plurality of resolution adjusting buttons 142a, 142b, 142c each corresponding to the plurality of resolution setting values, comments 151, and a resolution pattern window 152 having a predetermined picture 152a of which the resolution setting values are adjusted as each resolution adjusting button 142a, 142b, 142c is selected.

The resolution adjusting buttons 142a, 142b, 142c included in the resolution adjusting window 141 are included in correspondence to the capable resolutions of the display apparatus 20, e.g., VGA (video graphics array), SVGA (supper video graphics array), XGA (extended graphics array), VXGA (extended graphics array), SXGA (super extended graphics array), UXGA (ultra extended graphics array), etc. By way of example, FIG. 7 illustrates SVGA, XGA and SXGA buttons as the resolution adjusting buttons 142a, 142b, 142c. In an embodiment of the invention, the display setting program activates the resolution adjusting buttons only corresponding to the capable resolutions based on EDID (extended display identification data) of the display apparatus 20. When the display apparatus 20 is connected to the computer 10, the computer 10 reads EDID from the display apparatus 20 in order to perform the PNP and stores the read EDID in a memory unit such as a hard disk drive 13. Here, the display setting program reads the EDID stored in the memory unit before opening the resolution setting window “RE” and determines the capable resolution of the display apparatus 20 by the read EDID, thereby activating the resolution adjusting buttons only corresponding to the capable resolution of the display apparatus 20 among the resolution adjusting buttons 142a, 142b, 142c. Further, it should be appreciated that the display setting program reads the EDID from not the memory unit of the computer 10 but the memory of the display apparatus 20. Thus, when a user selects one of the resolution adjusting buttons 142a, 142b, 142c, the display setting program issues the command corresponding to the selected resolution adjusting button to the microprocessor 22 through the DDC-CI, and the microprocessor 22 adjusts the resolution of the picture 152a displayed on the picture area by the command. At this time, the microprocessor 22 controls the scaler 24 to adjust the resolution of the picture 152a displayed on the resolution pattern window 152 in correspondence to the selected resolution adjusting buttons 142a, 142b, 142c.

The resolution adjusting window 141 includes an optimizing window 143, an animation window 144, a previous button 147 and a next button 148 which correspond to the optimizing window 103, the animation window 104, the previous button 107 and the next button 108 included in the position adjusting window 101, respectively. Similarly, the optimizing window 143, the animation window 144, the previous button 147 and the next button 148 included in the resolution adjusting window 141 are identical with those of the position adjusting window 101 in the disposition, the display and the operation, so that repetitive descriptions will be avoided.

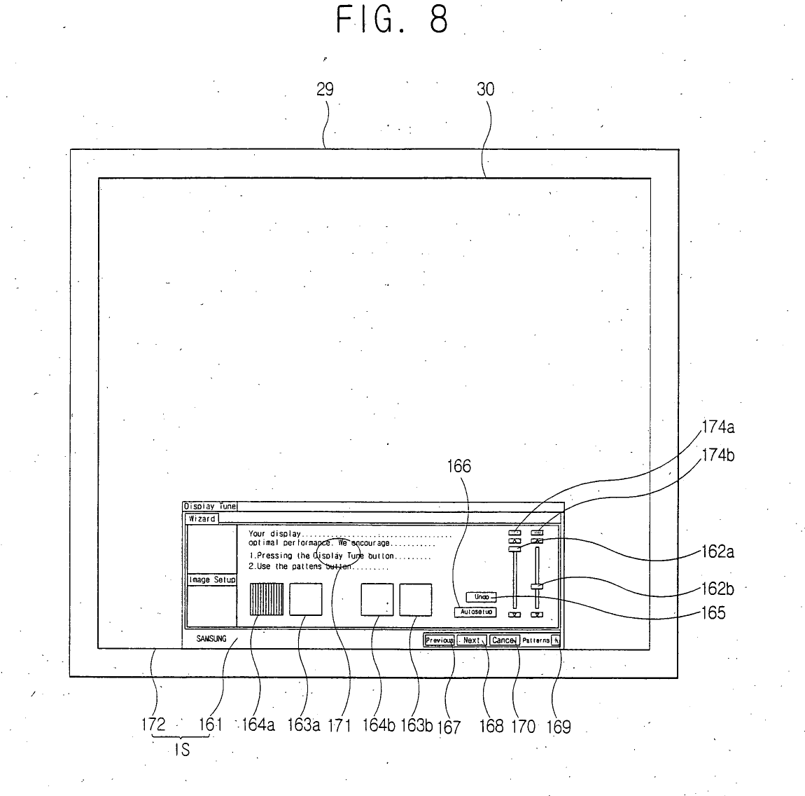

Fourth, when a user selects the next button 148 of the resolution adjusting window 141 after the resolution adjustment is completed, a clock/phase setting window “IS” is opened as shown in FIG. 8. The clock/phase setting window “IS” includes a picture setup adjusting window 161 having clock and phase drag bars 162a, 162b to be dragged on the picture setup adjusting window 161 so as to respectively adjust the clock and phase setting values, comments 171, and a clock/phase pattern window 172 of which the display is changed as the clock/phase drag bars 162a and 162b are dragged. Here, when a user drags one of the clock/phase drag bars 162a and 162b, the display setting program issues the command corresponding to the dragged clock or phase drag bar 162a or 162b to the microprocessor 22 through the DDC-CI, and the microprocessor 22 adjusts the clock or phase setting values of a predetermined picture displayed on the picture area in correspondence to the received command. At this time, the clock/phase pattern window 172 is adjusted in correspondence to the clock/phase setting values changed as the clock or phase drag bar 162a or 162b is dragged.

Further, the picture setup adjusting window 161 includes clock and phase level blocks 174a and 174b to represent the clock and phase setting values corresponding to the dragged positions of the clock and phase drag bars 162a and 162b as numerical values, respectively. In an embodiment of the invention, the clock and phase level block 174a and 174b are adjacent to the clock and phase drag bars 162a and 162b, respectively.

The picture setup adjusting window 161, in an embodiment of the invention, includes an undo button 165, optimizing windows 163a and 163b, animation windows 164a and 164b, a previous button 167 and a next button 168 which correspond to the undo button 105, the optimizing window 103, the animation window 104, the previous button 107 and the next button 108 included in the position adjusting window 101, respectively. Similarly, the undo button 165, the optimizing windows 163a and 163b, the animation windows 164a and 164b, the previous button 167 and the next button 168 included in the picture setup adjusting window 161 are identical with those of the position adjusting window 101 in the disposition, the display and the operation, so that repetitive descriptions will be avoided. Here, the optimizing windows 163a and 163b, and the animation windows 164a and 164b are included on the picture setup adjusting window 161 in correspondence to the clock and phase setting values, respectively.

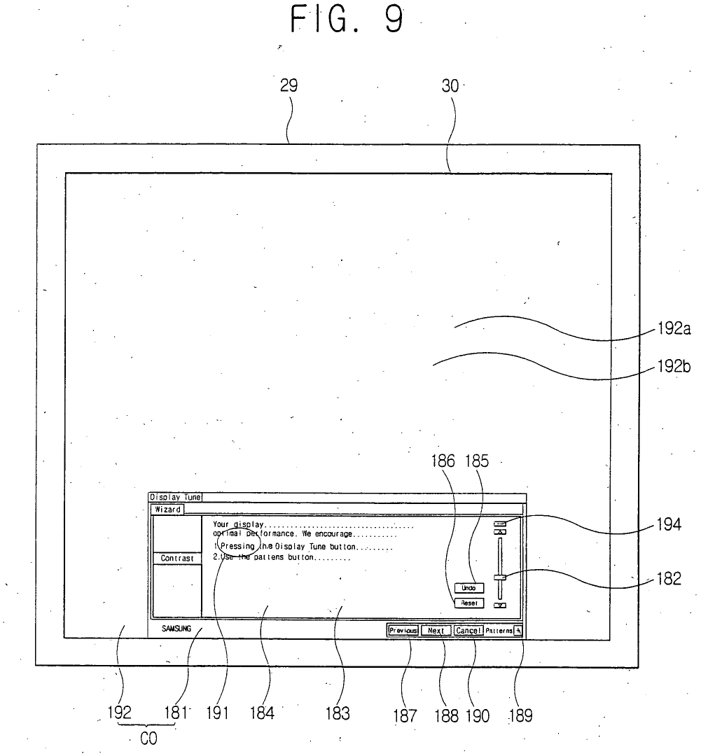

Fifth, when a user selects the next button 168 of the picture setup adjusting window 161 after the clock/phase adjustment is completed, a contrast setting window “CO” is opened as shown in FIG. 9. The contrast setting window “CO” includes a contrast adjusting window 181 having a contrast drag bar 182 to be dragged on the contrast adjusting window 181 so as to adjust the contrast setting value, comments 191, and a contrast pattern window 192 having a base block 192a and a pattern block 192b, wherein the pattern block 192b is included in the base block 192a and has the contrast to be changed as the contrast drag bar 182 is dragged. Here, when a user drags the contrast drag bar 182, the display setting program issues the command corresponding to the dragged contrast drag bar 182 to the microprocessor 22 through the DDC-CI, and the microprocessor 22 adjusts the contrast setting values of a predetermined picture displayed on the picture area in correspondence to the received command. At this time, the contrast of the pattern block 192b included in the contrast pattern window 192 is adjusted in correspondence to the contrast setting values changed as the contrast drag bar 182 is dragged.

Further, the contrast adjusting window 181 includes a contrast level block 194 to represent the contrast setting value corresponding to the dragged position of the contrast drag bar 182 as a numerical value. In an embodiment of the invention, the contrast level block 194 is adjacent to the contrast drag bar 182.

The contrast adjusting window 181 includes an undo button 185, a reset button 186, an optimizing window 183, an animation window 184, a previous button 187 and a next button 188 which correspond to the undo button 105, the reset button 106, the optimizing window 103, the animation window 104, the previous button 107 and the next button 108 included in the position adjusting window 101, respectively. Similarly, the undo button 185, the reset button 186, the optimizing window 183, the animation window 184, the previous button 187 and the next button 188 included in the contrast adjusting window 181 are identical with those of the position adjusting window 101 in the disposition, the display and the operation, so that repetitive descriptions will be avoided.

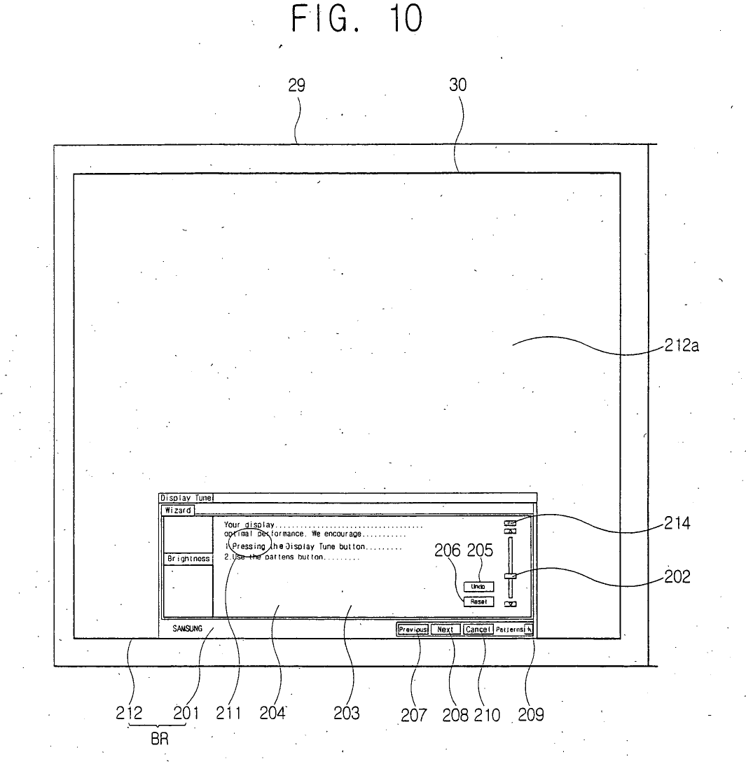

Sixth, when a user selects the next button 188 of the contrast adjusting window 181 after the contrast adjustment is completed, a brightness setting window “BR” is opened as shown in FIG. 10. The brightness setting window “BR” includes a brightness adjusting window 201 having a brightness drag bar 202 to be dragged on the brightness adjusting window 201 so as to adjust the brightness setting value, comments 211, and a brightness pattern window 212 having a gradation picture 212a of which the brightness is changed as the brightness drag bar 202 is dragged. Here, when a user drags the brightness drag bar 202, the display setting program issues the command corresponding to the dragged brightness drag bar 202 to the microprocessor 22 through the DDC-CI, and the microprocessor 22 adjusts the brightness setting values of a predetermined picture displayed on the picture area in correspondence to the received command. Concretely, the microprocessor 22 controls the backlight 28 to adjust the picture. At this time, the brightness of the gradation picture 212a included in the brightness pattern window 212 is adjusted in correspondence to the brightness setting values changed as the brightness drag bar 202 is dragged.

Further, the brightness adjusting window 201 includes a brightness level block 214 to represent the brightness setting value corresponding to the dragged position of the brightness drag bar 202 as a numerical value. In an embodiment of the invention, the brightness level block 214 is adjacent to the brightness drag bar 202.

The brightness adjusting window 201 includes an undo button 205, a reset button 206, an optimizing window 203, an animation window 204, a previous button 207 and a next button 208 which correspond to the undo button 105, the reset button 106, the optimizing window 103, the animation window 104, the previous button 107 and the next button 108 included in the position adjusting window 101, respectively. Similarly, the undo button 205, the reset button 206, the optimizing window 203, the animation window 204, the previous button 207 and the next button 208 included in the contrast adjusting window 201 are identical with those of the position adjusting window 101 in the disposition, the display and the operation, so that repetitive descriptions will be avoided.

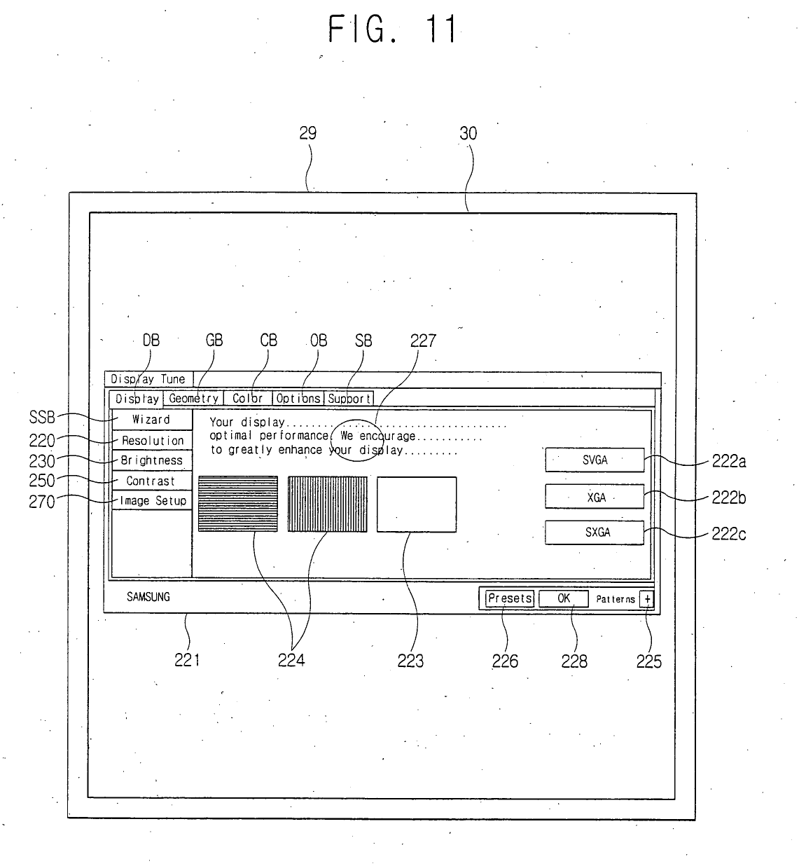

Seventh, when a user selects the next button 208 of the brightness adjusting window 201 after the brightness adjustment is completed, the display setting program opens an adjustment save window (not shown) allowing a user to save every display setting value adjusted by the foregoing adjusting processes. Then, when a user selects to save every adjusted display setting value, every adjusted display setting value is saved in the hard disk drive 13 as files so as to be loaded by the display setting program. Here, the files each containing the respective display setting values can be loaded by selecting preset buttons 226, 238, 258, 278, 297, 328, 317, 354, 364, 374, 384, 394, 404 of display setting windows 221, 231, 251, 271, 291, 311, 331, 351, 361, 371, 381, 391, 401 shown in FIGS. 11 through 23. When one of the loaded files is opened, the display setting program adjusts the display setting values on the basis of the display setting values contained in the files. Thus, a user can save the plurality of display setting values as one display condition, so that the display condition based on the plurality of display setting values can be adjusted by one selection. Here, at least one of the preset buttons 226, 238, 258, 278, 297, 328, 317, 354, 364, 374, 384, 394, 404 included in the display setting windows 221, 231, 251, 271, 291, 311, 331, 351, 361, 371, 381, 391, 401 may be inactivated. Further, at least one of the display setting windows 221, 231, 251, 271, 291, 311, 331, 351, 361, 371, 381, 391, 401 may not have the preset button.

It is understood that the sequence described above is not intended to limit the invention in any way. It is further noted that the display settings discussed above may be adjusted in any sequence according to this invention.

As described above, the process of sequentially adjusting the plurality of display settings by selecting the step start button “SSB” of the main window “SW” shown in FIG. 4 is completed.

Hereinbelow, a process of adjusting the display settings by selecting the menu buttons “DB, GB, CB” will be described with reference to FIGS. 11 through 23.

The menu buttons “DB, GB, CB” included on the main window “SW” correspond to at least one display setting group. Here, the display setting group includes at least one display setting. In this embodiment, the display setting group comprises a first setting group including the resolution setting, the brightness setting, the contrast setting, the clock setting and the phase setting; a second setting group including the position setting; and a third setting group including calibration setting and the color temperature setting. Thus, the menu buttons “DB, GB, CB” comprise a display button “DB” corresponding to the first setting group, a geometry button “GB” corresponding to the second setting group, and a color button “CB” corresponding to the third setting group. Here, when each menu button “DB, GB, CB” is selected, a window to adjust the display setting belonging to the corresponding setting group is opened.

On the other hand, when the display button “DB” of the main window “SW” is selected, a display adjusting window is opened, wherein the display adjusting window includes a resolution button 220 corresponding to the resolution setting, a brightness button 230 corresponding to the brightness setting, a contrast button 250 corresponding to the contrast setting, and a picture setup button 270 corresponding to the clock/phase setting. In this embodiment, the display adjusting window is identical with the main window “SW”, but may be displayed separately from the main window “SW”.

As shown in FIG. 11, when a user selects the resolution button 220 displayed on the display adjusting window (in this embodiment, the resolution button 220 is displayed on the main window shown in FIG. 4), a resolution adjusting window 221 having a plurality of resolution adjusting buttons 222a, 222b, 222c each corresponding to the plurality of resolution setting values opens. The resolution adjusting buttons 222a, 222b, 222c are included in correspondence to the capable resolutions of the display apparatus 20, e.g., the VGA, the SVGA, the XGA, the VXGA, the SXGA, the UXGA, etc. By way of example, FIG. 11 illustrates SVGA, XGA and SXGA buttons as the resolution adjusting buttons 222a, 222b, 222c. Here, the capable resolutions are based on the EDID stored in the display apparatus 20, and it is preferable that the selectable resolution adjusting buttons only corresponding to the capable resolutions based on the EDID are activated. When the display apparatus 20 is connected to the computer 10, the computer 10 reads EDID from the display apparatus 20 in order to perform the PNP and stores the read EDID in a memory unit such as a hard disk drive 13. Therefore, the display setting program reads the EDID stored in the memory unit before opening the resolution adjusting window 221 and determines what resolution adjusting buttons correspond to the capable resolutions based on EDID of the display apparatus 20, thereby selectively activating the resolution adjusting buttons 222a, 222b, 222c related to the capable resolutions of the display apparatus 20. Further, it should be appreciated that the display setting program can read the EDID not from the memory unit of the computer 10 but the memory of the display apparatus 20 directly. Thus, when a user selects one of the resolution adjusting buttons 142a, 142b, 142c, the display setting program issues the command corresponding to the selected resolution adjusting button to the microprocessor 22 through the DDC-CI, and the microprocessor 22 adjusts the resolution of the picture displayed on the picture area by the received command.

Additionally, the resolution adjusting window 221 includes a pattern activating button 225. When a user selects the pattern activating button 225, a resolution pattern window of which the resolution is changed corresponding to the selected resolution adjusting button 222a, 222b, 222c is opened. Here, the resolution pattern window is identical with the resolution pattern window 152 of the resolution setting window “RE” according to the processes of sequentially adjusting the display settings in the disposition, the display and the operation, so that repetitive descriptions will be avoided.

Further, the resolution adjusting window 221 includes an ok button 228. When a user selects the ok button 228, the changed resolution setting value is saved in the memory of the display apparatus 20.

Further, the resolution adjusting window 221 includes an optimizing window 223, comments 227, and an animation window 224. Here, the optimizing and animation windows 223 and 224 of the resolution adjusting window 221 are identical with the optimizing and animation windows 143 and 144 of the resolution adjusting window 141 according to the processes of sequentially adjusting the display settings in the disposition, the display and the operation, so that the repetitive descriptions will be avoided.

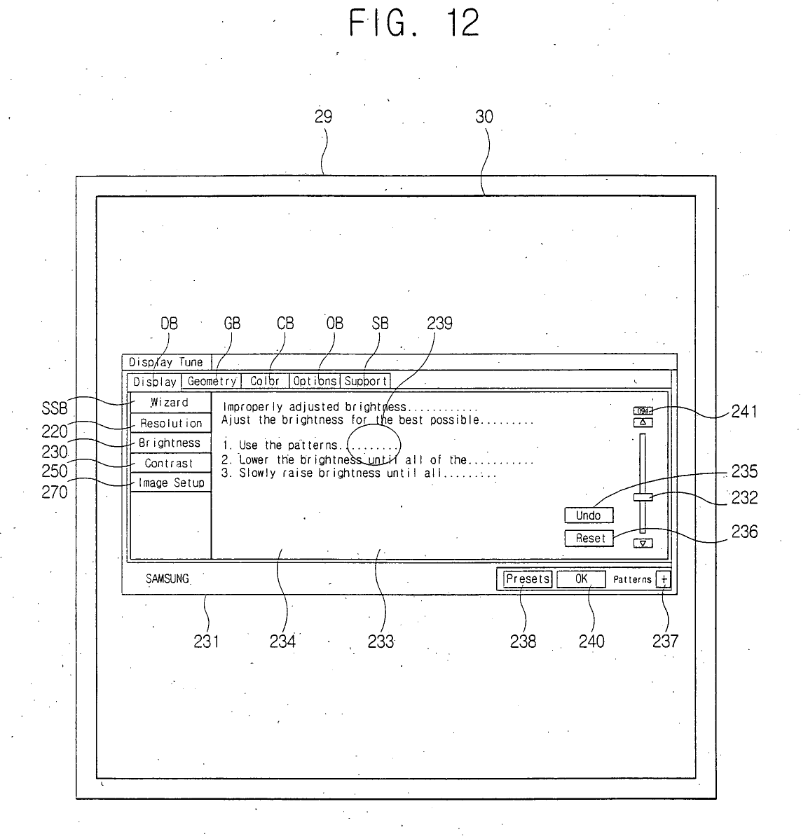

As shown in FIG. 12, when a user selects the brightness button 230, a brightness adjusting window 231 having a brightness drag bar 232 to be dragged on the brightness adjusting window 231 so as to adjust the brightness setting value is opened. Here, when a user drags the brightness drag bar 232, the display setting program issues the command corresponding to the dragged brightness drag bar 232 to the microprocessor 22 through the DDC-CI, and the microprocessor 22 adjusts the brightness of a predetermined picture displayed on the picture area in correspondence to the received command.

Additionally, the brightness adjusting window 231 includes a pattern activating button 237. When a user selects the pattern activating button 237, a brightness pattern window, having a gradation picture of which the brightness is changed as the brightness drag bar 232 is dragged, is opened. Here, the brightness pattern window is identical with the brightness pattern widow 212 of the brightness setting window “BR” according to the processes of sequentially adjusting the display settings in the disposition, the display and the operation, so that repetitive descriptions will be avoided.

Further, the brightness adjusting window 231 includes a brightness level block 241 to represent the brightness setting value corresponding to the dragged position of the brightness drag bar 232 as a numerical value. In an embodiment of the invention, the brightness level block 241 is adjacent to the brightness drag bar 232.

Further, the brightness adjusting window 231 includes an ok button 240. When a user selects the ok button 240, the changed brightness setting value is saved in the memory of the display apparatus 20.

Further, the brightness adjusting window 231 includes comments 239, an undo button 235, a reset button 236, an optimizing window 233 and an animation window 234. Here, the undo button 235, the reset button 236, the optimizing window 233 and the animation window 234 of the brightness adjusting window 231 are identical with the undo button 205, the reset button 206, the optimizing window 203 and the animation window 204 of the brightness adjusting window 201 according to the processes of sequentially adjusting the display settings in the disposition, the display and the operation, so that the repetitive descriptions will be avoided.

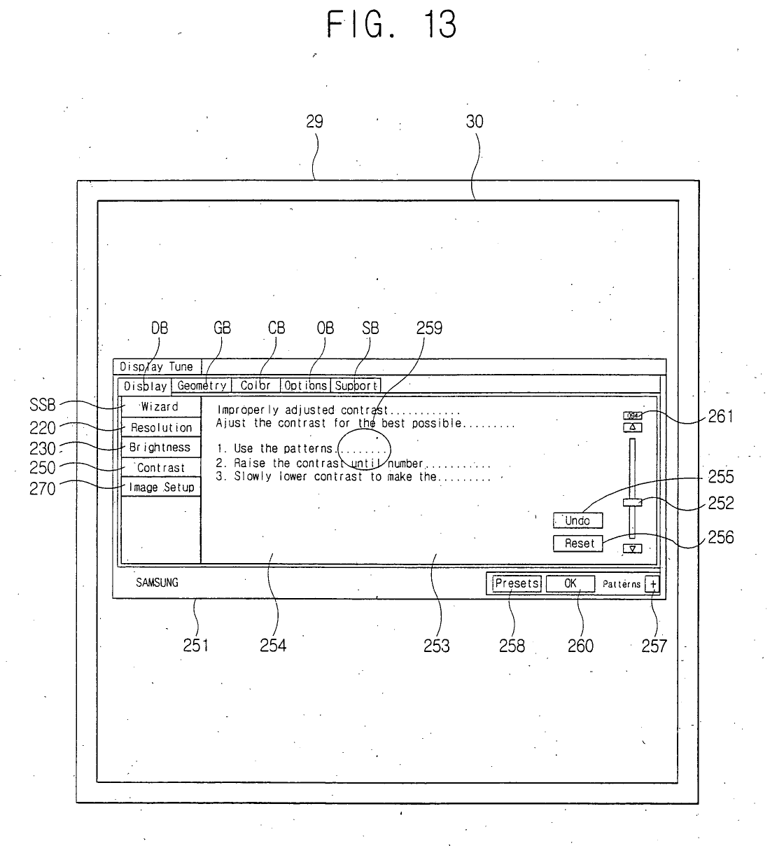

As shown in FIG. 13, when a user selects the contrast button 250, a contrast adjusting window 251, having a contrast drag bar 252 to be dragged on the contrast adjusting window 251 so as to adjust the contrast setting value, is opened. Here, when a user drags the contrast drag bar 252, the display setting program issues the command corresponding to the dragged contrast drag bar 252 to the microprocessor 22 through the DDC-CI, and the microprocessor 22 adjusts the contrast setting values of a predetermined picture displayed on the picture area in correspondence to the received command.

Additionally, the contrast adjusting window 251 includes a pattern activating button 257 and comments 259. When a user selects the pattern activating button 257, a contrast pattern window having a base block and a pattern block, wherein the pattern block is included in the base block and has the contrast to be changed as the contrast drag bar 252 is dragged. Here, the contrast pattern window is identical with the contrast pattern widow 192 of the contrast setting window “CO” according to the processes of sequentially adjusting the display settings in the disposition, the display and the operation, so that repetitive descriptions will be avoided.

Further, the contrast adjusting window 251 includes a contrast level block 261 to represent the contrast setting value corresponding to the dragged position of the contrast drag bar 252 as a numerical value. In an embodiment of the invention, the contrast level block 252 is adjacent to the contrast drag bar 252.

Further, the brightness adjusting window 251 includes an ok button 260. When a user selects the ok button 260, the changed contrast setting value is saved in the memory of the display apparatus 20.

Further, the contrast adjusting window 251 includes an undo button 255, a reset button 256, an optimizing window 253 and an animation window 254. Here, the undo button 255, the reset button 256, the optimizing window 253 and the animation window 254 of the contrast adjusting window 251 are identical with the undo button 185, the reset button 186, the optimizing window 183 and the animation window 184 of the contrast adjusting window 181 according to the processes of sequentially adjusting the display settings in the disposition, the display and the operation, so that the repetitive descriptions will be avoided.

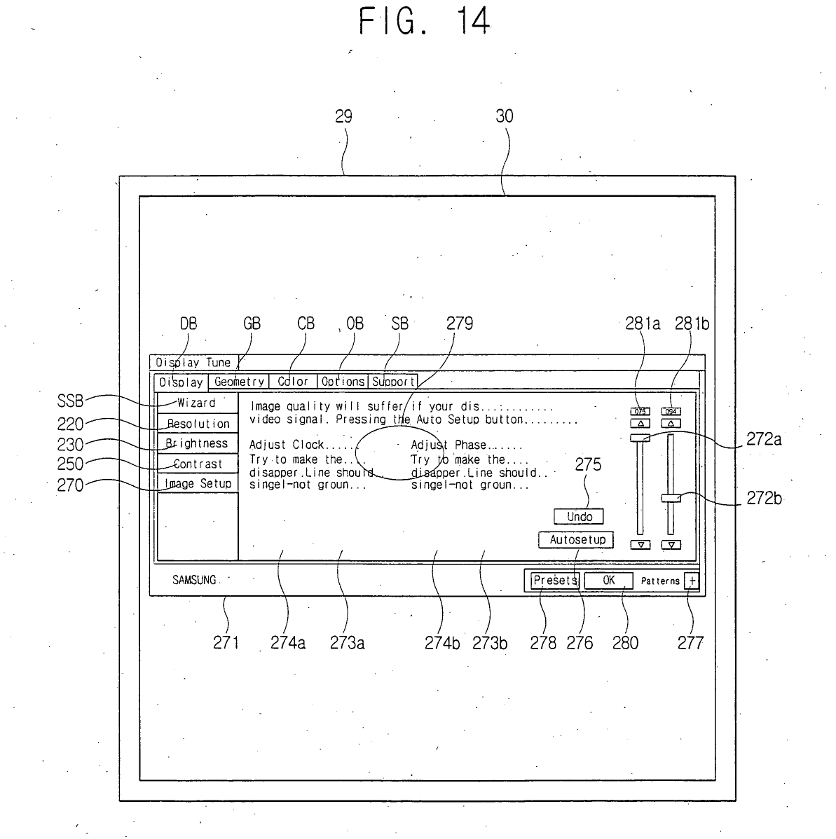

As shown in FIG. 14, when a user selects the picture setup button 270, a picture setup adjusting window 271, having clock and phase drag bars 272a, 272b to be dragged on the picture setup adjusting window 271 so as to respectively adjust the clock and phase setting values and comments 279, is opened. Here, when a user drags the clock or phase drag bar 272a or 272b, the display setting program issues the command corresponding to the dragged clock or phase drag bar 272a or 162b to the microprocessor 22 through the DDC-CI, and the microprocessor 22 adjusts the clock or phase setting values of a predetermined picture displayed on the picture area in correspondence to the received command.

Additionally, the picture setup adjusting window 271 includes a pattern activating button 277. When a user selects the pattern activating button 277, a clock/phase pattern window of which the display is changed as the clock or phase drag bar 272a or 272b is dragged is opened. Here, the clock/phase pattern window is identical with the clock/phase pattern widow 172 of the clock/phase setting window “IS” according to the processes of sequentially adjusting the display settings in the disposition, the display and the operation, so that repetitive descriptions will be avoided.

Further, the picture setup adjusting window 271 includes clock and phase level blocks 281a and 281b to represent the clock and phase setting values corresponding to the dragged positions of the clock and phase drag bars 272a and 272b as numerical values, respectively. In an embodiment of the invention, the clock and phase level block 281a and 281b are adjacent to the clock and phase drag bars 272a and 272b, respectively.

Further, the picture setup adjusting window 271 includes an ok button 280. When a user selects the ok button 280, the changed clock/phase setting value is saved in the memory of the display apparatus 20.

Further, the picture setup adjusting window 271 includes an undo button 275, optimizing windows 273a and 273b and animation windows 274a and 274b. Here, the undo button 275, the optimizing windows 273a and 273b and the animation windows 274a and 274b of the picture setup adjusting window 271 are identical with the undo button 165, the optimizing windows 163a and 163b and the animation windows 164a and 164b included in the picture setup adjusting window 161 of the clock/phase setting window “IS” according to the processes of sequentially adjusting the display settings in the disposition, the display and the operation, so that the repetitive descriptions will be avoided.

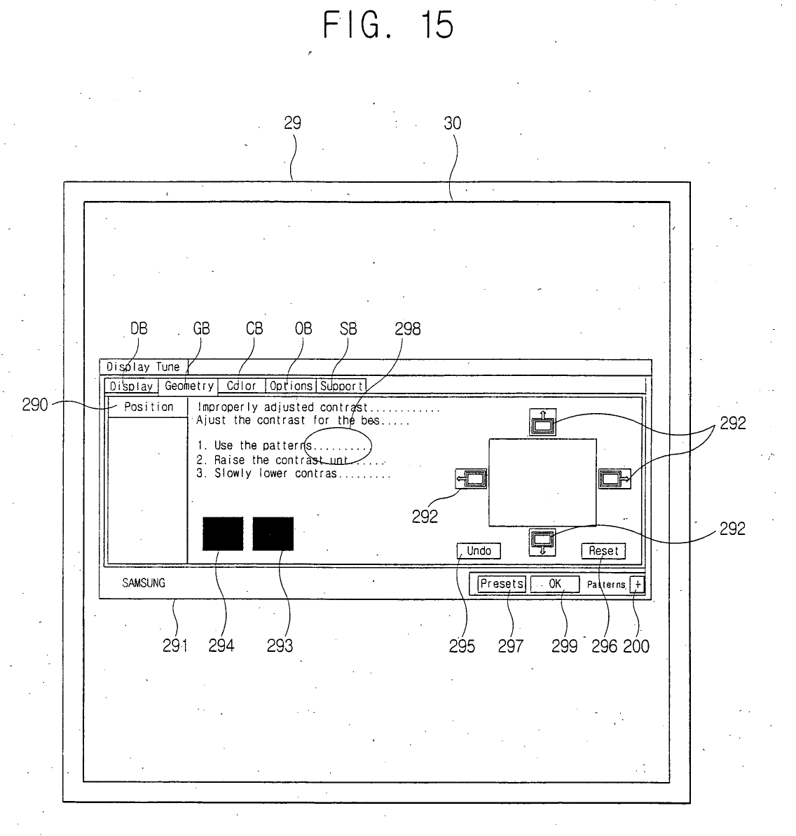

On the other hand, when a user selects the geometry button “GB”, as shown in FIG. 4, a geometry setting window is opened, as shown in FIG. 15. In this embodiment, the geometry setting window includes only a position button 290 corresponding to the position setting belong to the second setting group. However, the second setting group may include size setting to adjust the size of the picture area relative to the screen. Here, the geometry setting window is identical with a position adjusting window 291.

When a user selects the position button 290, a position adjusting window 291, having four position adjusting buttons 292 to control the picture area to move in up, down, left and right directions on the screen and comments 298, is opened as shown in FIG. 15. Here, when a user selects the position adjusting button 292, the display setting program issues the command corresponding to the selected position adjusting button 292 to the microprocessor 22 through the DDC-CI, and the microprocessor 22 controls the picture area to move on the screen in correspondence to the received command.

Additionally, the position adjusting window 291 includes a pattern activating button 300. When a user selects the pattern activating button 300, a position pattern window displayed on the picture area except the area occupied with the position adjusting window 291 is opened. Here, the position pattern window is identical with the position pattern widow 112 of the position setting window “PO” according to the processes of sequentially adjusting the display settings in the disposition, the display and the operation, so that repetitive descriptions will be avoided.

Further, the position adjusting window 291 includes an ok button 229. When a user selects the ok button 229, the changed position setting value is saved in the memory of the display apparatus 20.

Further, the position adjusting window 291 includes an undo button 295, a reset button 296, an optimizing window 293 and an animation window 294. Here, the undo button 295, the reset button 296, the optimizing window 293 and the animation window 294 of the position adjusting window 291 are identical with the undo button 105, the reset button 106, the optimizing window 103 and the animation window 104 included in the position adjusting window 101 of the position setting window “PO” according to the processes of sequentially adjusting the display settings in the disposition, the display and the operation, so that the repetitive descriptions will be avoided.

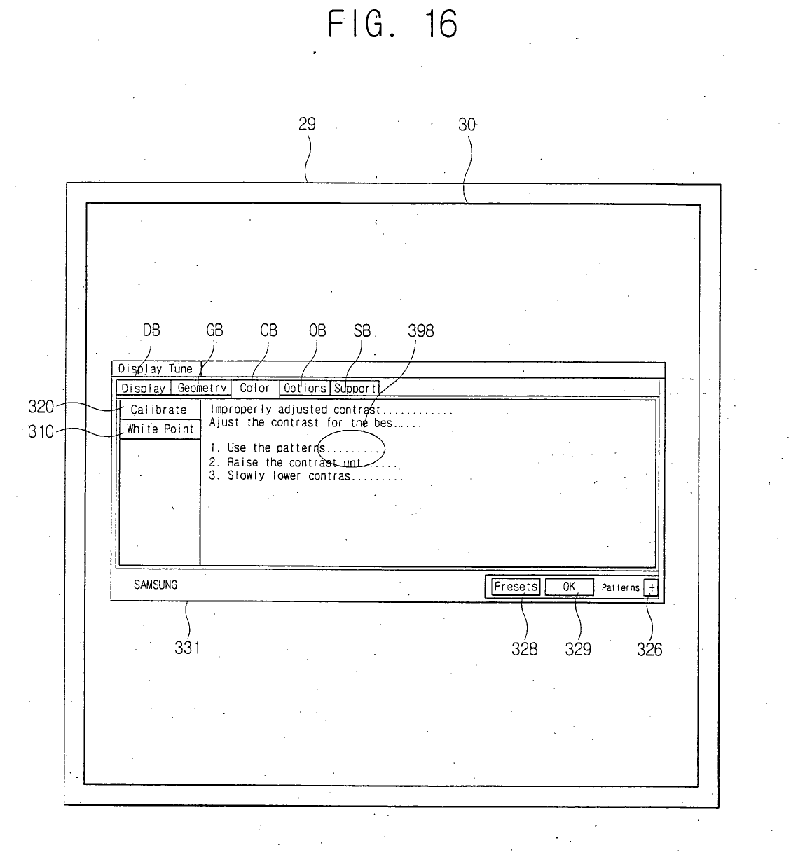

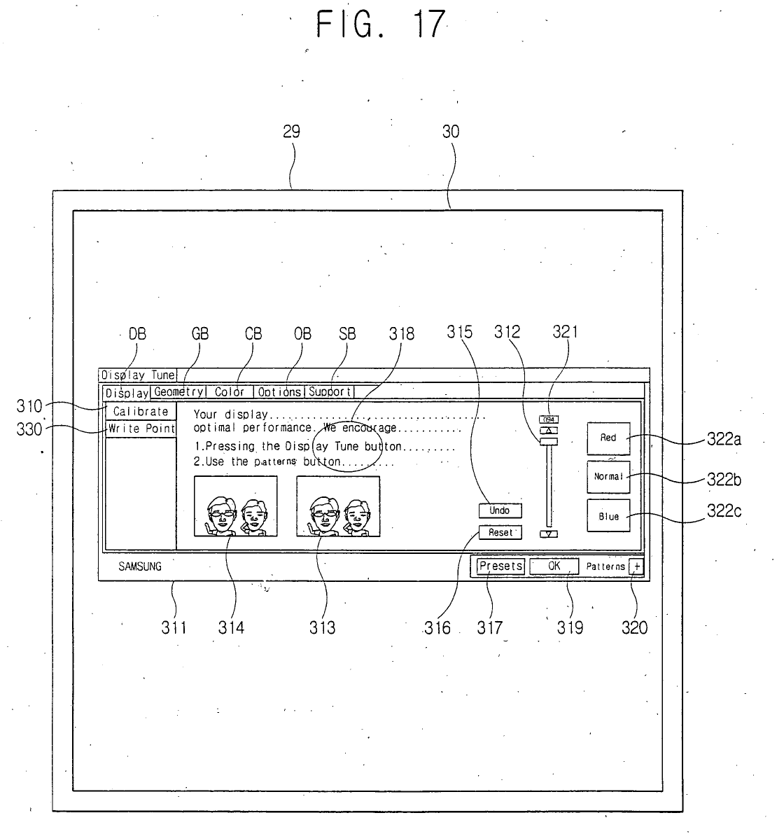

On the other hand, when a user selects the color buttons “CB” among the menu buttons “DB, GB, CB”, as shown in FIG. 4, a color adjusting window 331 is opened, as shown in FIGS. 16 and 17, wherein the color adjusting window 331 includes a calibration button 330 corresponding to the calibration setting, comments 398, and a color temperature button 310 corresponding to the color temperature setting.

When a user selects the color temperature button 310, a color temperature adjusting window 311, having a color temperature drag bar 312 to be dragged on the color temperature adjusting window 311 so as to adjust the color temperature setting value and comments 318, is opened. Here, when a user drags the color temperature drag bar 312, the display setting program issues the command corresponding to the dragged color temperature drag bar 312 to the microprocessor 22 through the DDC-CI, and the microprocessor 22 adjusts the color temperature of the picture displayed on the picture area in correspondence to the received command.

Additionally, the color temperature adjusting window 311 includes a pattern activating button 320. When a user selects the pattern activating button 320, a color temperature pattern window having a predetermined picture of which the color temperature is changed corresponding to the color temperature setting value as the color temperature drag bar 312 of the color temperature adjusting window 311 is dragged. Here, the color temperature pattern window is identical with the color temperature pattern widow 132 of the color temperature setting window “WP” according to the processes of sequentially adjusting the display settings in the disposition, the display and the operation, so that repetitive descriptions will be avoided.

Further, the color temperature adjusting window 311 includes a color temperature level block 321 to represent the color temperature setting value corresponding to the dragged color temperature drag bar 312 as a numerical value. In an embodiment of the invention, the color temperature level block 321 is adjacent to the color temperature drag bar 312.

Further, the color temperature adjusting window 311 includes a red button 322a to increase a red color temperature setting value, a blue button 322c to increase a blue color temperature setting value, and a normal button 322b to adjust the color temperature setting value to mediate between the red color temperature setting value and the blue color temperature setting value. When a user selects the red button 322a, the color temperature of the picture displayed on the picture area is increased in red. When a user selects the blue button 322c, the color temperature of the picture displayed on the picture area is increased in blue.

Further, the color temperature adjusting window 311 includes an ok button 319. When a user selects the ok button 319, the changed color temperature setting value is saved in the memory of the display apparatus 20.

Further, the color temperature adjusting window 311 includes an undo button 315, a reset button 316, an optimizing window 313 and an animation window 314. Here, the undo button 315, the reset button 316, the optimizing window 313 and the animation window 314 of the color temperature adjusting window 311 are identical with the undo button 125, the reset button 126, the optimizing window 123 and the animation window 124 included in the color temperature adjusting window 121 of the color temperature setting window “WP” according to the processes of sequentially adjusting the display settings in the disposition, the display and the operation, so that the repetitive descriptions will be avoided.

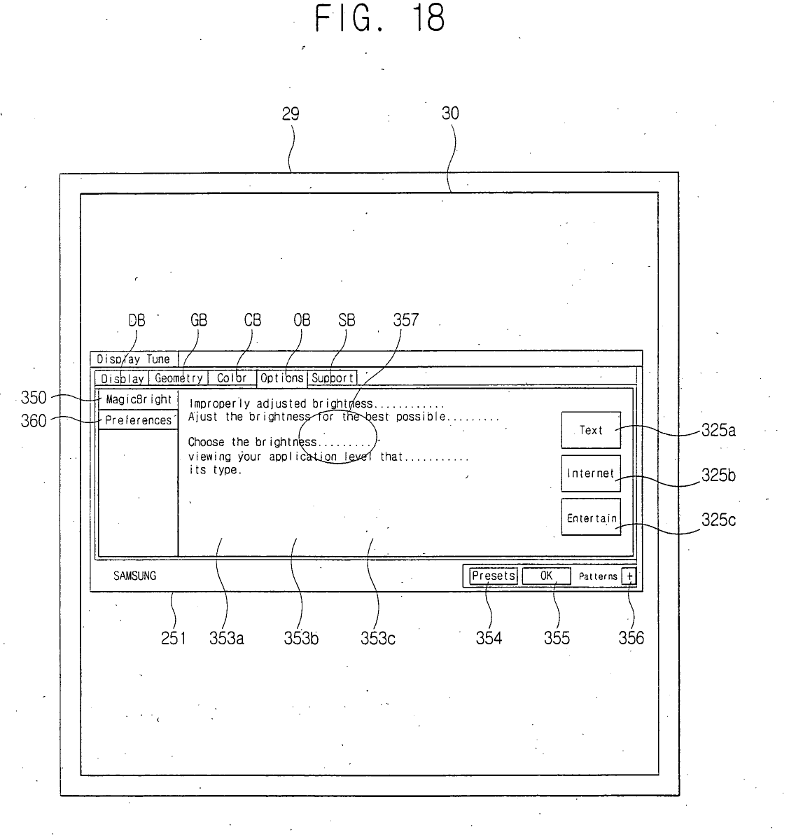

According to the present invention, the main window “SW” further includes an option button “OB” as shown in FIG. 4. On the other hand, when a user selects the option button “OB”, an option adjusting window having a magic bright button 350 and a preferences button 360 is opened. In this embodiment, the option adjusting window is identical with a magic bright setting window 351 shown in FIG. 18, but may be displayed separately from the magic bright setting window 351.

Meanwhile, when a user selects the magic bright button 350, the magic bright setting window 351 is opened. Through the magic bright setting window 351, a user can adjust magic bright setting. The magic bright setting is to adjust the brightness of the picture displayed on the picture area according to a specific type picture, so that the magic bright setting window 351 includes a plurality of setting buttons 352a, 352b, 352c according to the specific type picture. In this embodiment, the setting buttons includes a text button 352a, an internet button 352b, an entertain button 352c by way of example, and comments 357. When a user selects the text button 352a, the picture area occupied with a word processor window for a text is displayed more brightly than the other area. Further, when a user selects the internet button 352b, the picture area occupied with an internet browsing window of the Internet is displayed more brightly than the other area.

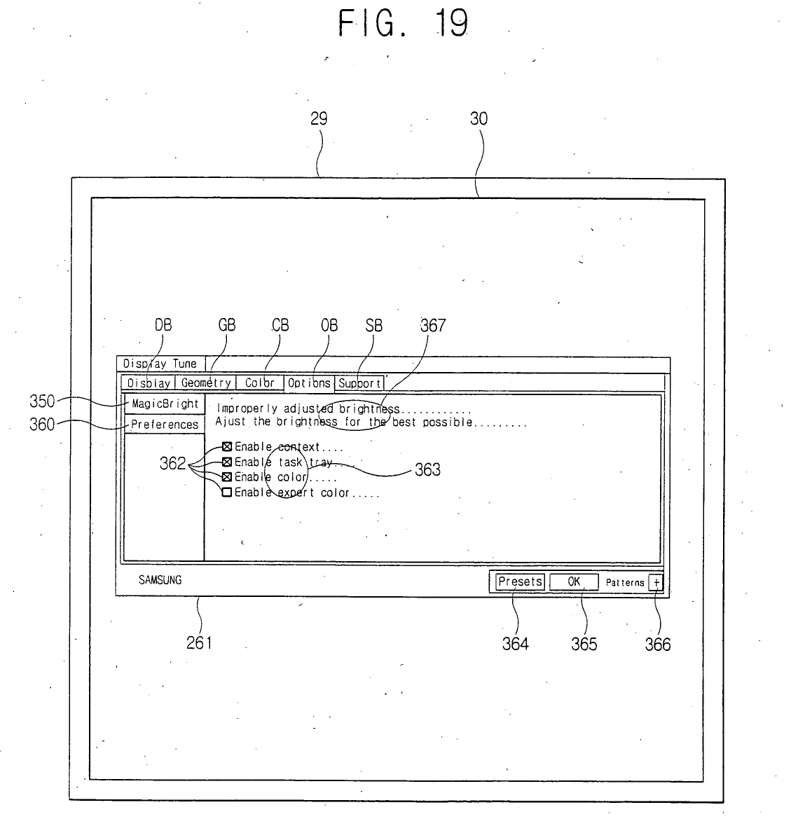

Meanwhile, when a user selects a preferences button 360, a preferences setting window 361 is opened as shown in FIG. 19. The preferences setting window 361 displays a comment 367 on the preference setting, a plurality of check boxes 362 of a plurality of sub-settings, and a plurality of check box comments 363 on the respective check boxes 362. The sub-settings to be selected by checking the check box 362 include a setting to choose whether or not an icon to execute the display setting program is displayed in a system tray of Windows™.

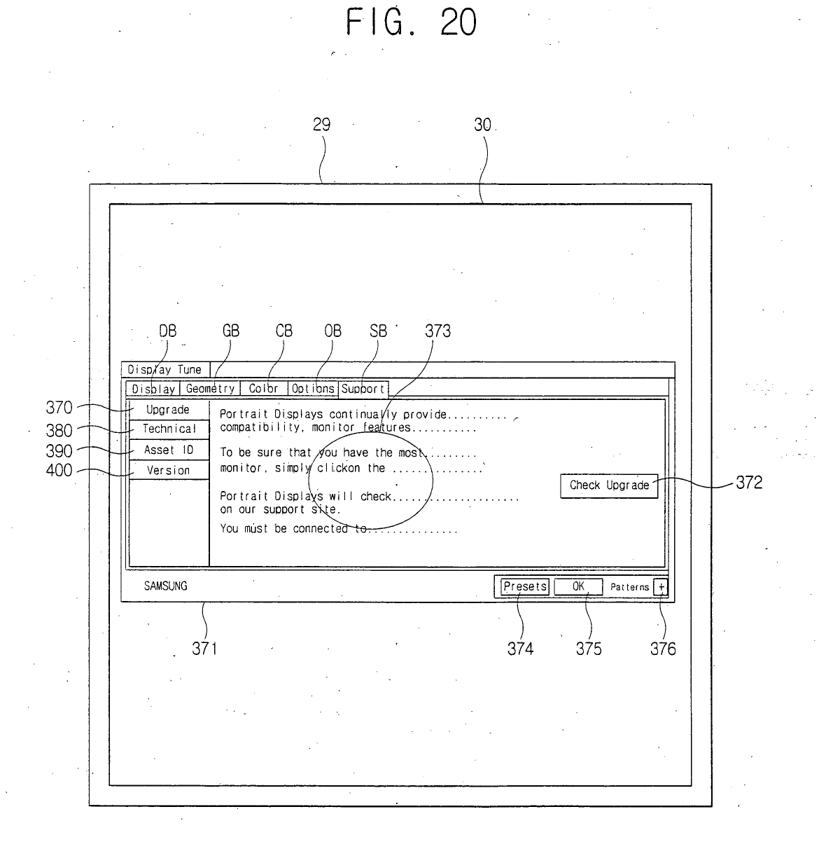

According to the present invention, the main window “SW” further includes a support button “SB” as shown in FIG. 4. On the other hand, when a user selects the support button “SB”, a support adjusting window having an upgrade button 370, a technical button 380, an asset ID (identification) button 390, and a version button 400 is opened. In this embodiment, the support adjusting window is identical with an upgrading window 371 shown in FIG. 20, but may be displayed separately from the magic bright setting window 351.

Meanwhile, when a user selects the upgrade button 370, an upgrading window 371, having an upgrade check button 372 to upgrade the display setting program, and comments 373 is opened, as shown in FIG. 20. If a user selects the upgrade check button 372, the display setting program has access to an upgrade supporting system through a communication module such as a modem of the computer 10, wherein the upgrade supporting system includes an upgrading homepage that is administered by a vendor of the display setting program or the display apparatus 20 and supports the upgrade of the display setting program. Thus, a user can download upgrade information or an upgrade version of the display setting program.

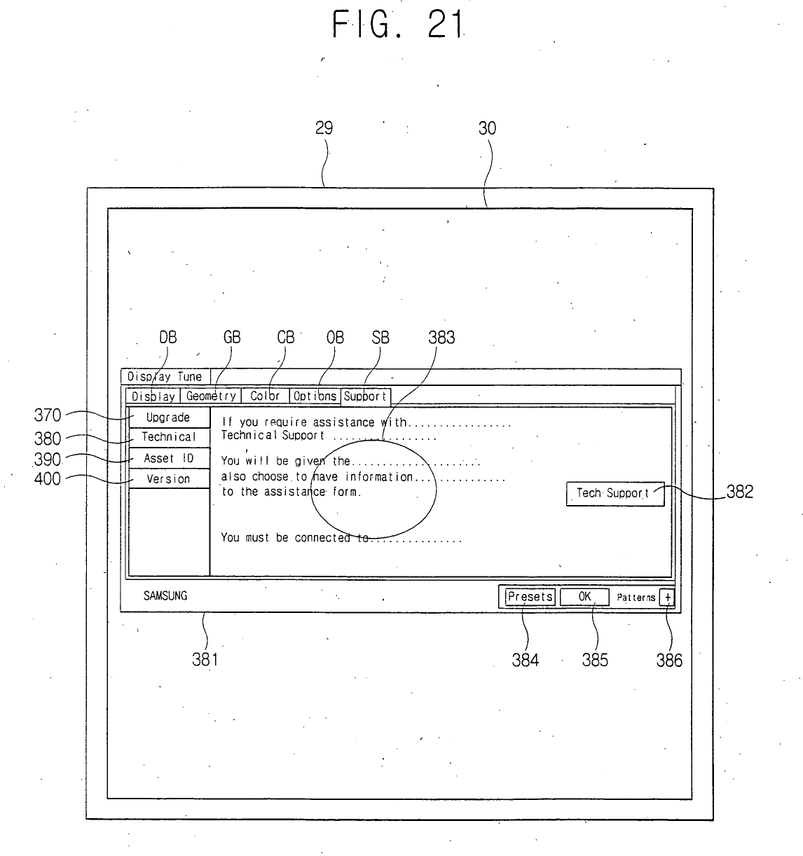

Meanwhile, when a user selects the technical button 380, a technical supporting window 381 having a technical supporting button 382 to receive technical support from a technical supporting system is opened and comments 383, as shown in FIG. 21. If a user selects the technical supporting button 382, the display setting program has access to the technical supporting system through the communication module such as the modem of the computer 10, wherein the technical supporting system includes a technical supporting homepage that is administered by a vendor of the display setting program or the display apparatus 20.

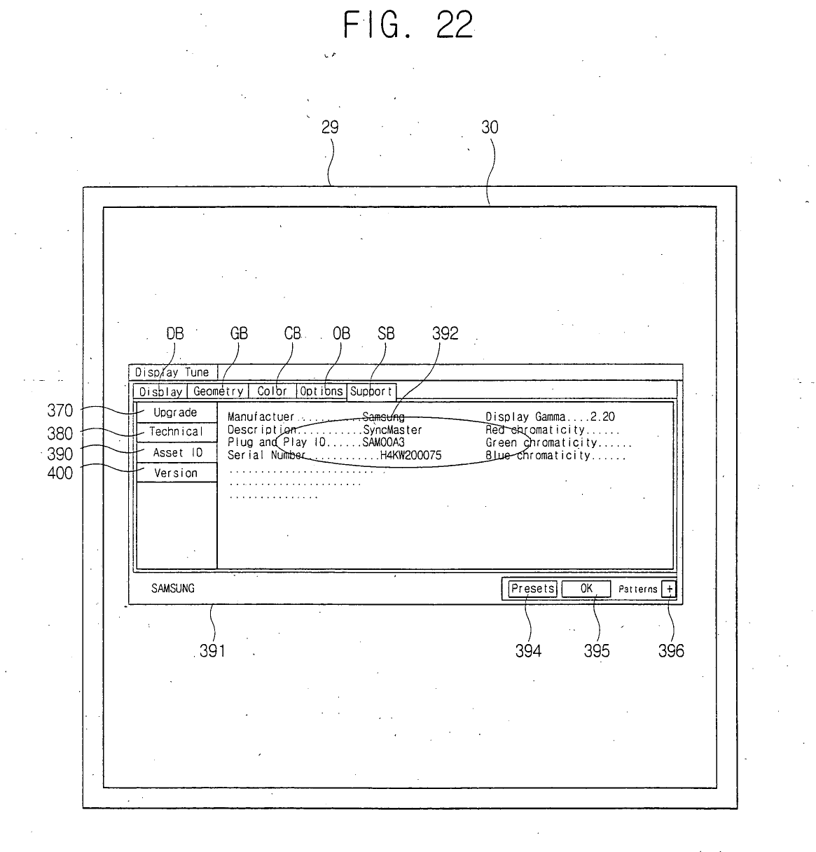

Meanwhile, when a user selects the asset ID button 390, a display apparatus information window 391 having comments 392 on information of the display apparatus 20 is opened, as shown in FIG. 22. Here, the information of the display apparatus 20 is based on the EDID. Further, the display setting program can read the EDID from either of the memory unit of the computer 10 or the memory of the display apparatus 20. The comments 392 displayed on the display apparatus information window 391 includes information on a manufacturer, a PNP ID, serial number, manufacturing date, etc.

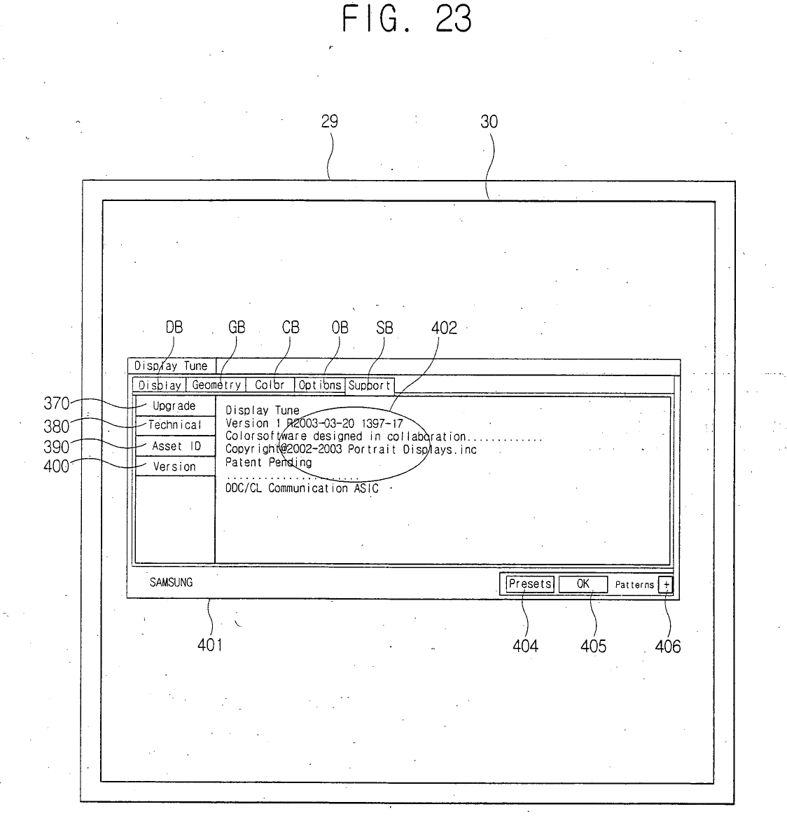

Meanwhile, when a user selects the version button 400, the version information window 401 having comments 402 on a version information of the display setting program is opened, as shown in FIG. 23. Here, the version information includes a program name, a version, a designer, etc.

In FIGS. 5 through 10, the reference numerals 110, 130, 150, 170, 190 and 210 indicate cancel buttons to finish the display setting program. Further, in FIGS. 5 through 10, the reference numerals 109, 129, 149, 169, 189, 209 indicate the pattern activating buttons allowing the pattern windows 112, 132, 152, 172, 192, 212 to be activated on or hidden from the picture area, or to be changed into a predetermined picture.

In FIGS. 8 and 14, the reference numerals 166, 276 indicate auto-setup buttons to change at least one of the display settings of the picture displayed on the picture area into saved display settings. In the present embodiment, when the auto-setup button is selected, the position setting and the clock/phase setting are adjusted into the display settings saved in the memory unit of the computer 10 or the memory of the display apparatus 20.

As described above, there is included a method comprising: connecting the display apparatus with the external device, making the two-way communication therebetween possible; displaying the main window including the step start buttons included to adjust the plurality of display settings of the picture displayed on the picture area sequentially, and at least one menu button included to adjust the display settings of the picture displayed on the picture area individually; selecting one of the step start buttons and the menu buttons; displaying the display setting window corresponding to the selected button; adjusting the display settings through the displayed display setting window; issuing the command from the external device in correspondence to adjusting the display settings; and setting the display settings in correspondence to the received command, so that the present invention provides a convenient user interface to adjust the plurality of display settings of the picture displayed on the picture area.

As described above, the present invention provides a convenient user interface to adjust a plurality of display settings of a picture displayed on a picture area.

It is understood that the present invention can be used with a variety of display devices including, although not limited to, computer monitors, hand-held devices, televisions, and plasma display devices.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A method to provide a convenient user interface to change a display setting of a picture area of a display apparatus, which communicates with an external device, the method comprising:
displaying a main window, including a step start button to initiate a sequence of at least first and second display setting adjustment windows in which first and second display setting adjustments are made;
sequentially displaying the display setting adjustment windows corresponding to a selection of the step start button;
adjusting the display setting through the displayed display setting adjustment windows;
issuing a command from the external device in correspondence to adjusting the displayed display setting adjustment windows; and
setting the display setting in correspondence to the command.

2. The method according to claim 1, wherein the main window includes a menu button to separately adjust the display settings.

3. The method according to claim 1, wherein the display setting adjustments are selected from the following:
a picture position adjustment;
a color temperature adjustment;
a resolution adjustment;
clock and phase adjustments;
a contrast adjustment; and
a brightness adjustment.

4. The method according to claim 1, wherein a last display setting adjustment window in the sequence includes a button to open an adjustment save window to save adjusted display settings.

5. The method according to claim 4, further comprising saving the adjusted display settings as a file through the adjustment save window.

6. The method according to claim 5, further comprising:
opening the file;
adjusting a display setting on the basis of the saved adjusted display setting in the opened file.

7. The method according to claim 1, wherein at least one of the display setting adjustment windows comprise an undo button to undo the display setting adjustment.

8. The method according to claim 1, wherein at least one of the display setting adjustment windows comprise a reset button to return the display setting to a default setting.

9. The method according to claim 1, wherein the menu button is plural in number and comprises:
a display button corresponding to a first setting group including a resolution setting, a brightness setting, a contrast setting, and a clock and phase setting;
a geometry button corresponding to a second setting group including a position setting; and
a color button corresponding to a third setting group including a calibration setting, and a color temperature setting, wherein when each menu button is selected, a window to adjust the display setting belonging to the corresponding setting group is opened.

10. The method according to claim 9, wherein when the display button is selected, a display adjusting window is opened, the display adjusting window comprising:
a resolution button corresponding to the resolution setting;
a brightness button corresponding to the brightness setting;
a contrast button corresponding to the contrast setting; and
a picture setup button corresponding to the clock and phase setting, is opened.

11. The method according to claim 10, wherein when one of the buttons is selected, a adjusting window, in which a display setting adjustment corresponding to the selected button is made, is opened.

12. The method according to claim 11, wherein the adjusting window comprises a pattern activating button to open a pattern window having an image which is changed as the display setting adjustment are made in the adjusting window.

13. The method according to claim 11, wherein the adjusting window comprises:
an undo button to undo the display setting adjustment;
a reset button to return the display setting to a default setting; and
an animation window to show an animation of the display setting adjustment.

14. The method according to claim 9, wherein when the geometry button is selected, a geometry setting window, including a position button, corresponding to the second setting group, is opened.

15. The method according to claim 14, wherein the geometry setting window comprises a pattern activating button to open a pattern window having a picture which is changed as the display setting adjustment are made in the adjusting window.

16. The method according to claim 14, wherein the adjusting window comprises:
an undo button to undo a position adjustment;
a reset button to return a position setting to a default setting; and
an animation window to show an animation of a position adjustment.

17. The method according to claim 9, wherein when the color button is selected a color adjusting window, including a calibration button corresponding to a calibration setting and a color temperature button corresponding to a color temperature of the picture displayed by the display apparatus, is opened.

18. The method according to claim 17, wherein when a user selects the color temperature button, a color temperature adjusting window, in which a color temperature of the picture displayed by the display apparatus is adjusted, is opened.

19. The method according to claim 18, wherein the color temperature adjusting window comprises a pattern activating button, wherein when the pattern activating button is selected, a color temperature pattern window, having a picture with a color temperature that is changed as the color temperature is adjusted in the color temperature adjusting window, is opened.

20. The method according to claim 18, wherein the color temperature adjusting window further comprises:
an undo button to undo a color temperature adjustment;
an optimizing window to display an optimized color temperature setting of the picture area; and
an animation window to show an animation of a color temperature adjustment.

21. The method according to claim 9, wherein the menu further comprises:
an option button to open an option adjusting window having a magic bright button and a preferences button;
a support button to open a support adjusting window having an upgrade button, a technical button, an asset ID button, and a version button.

22. A display apparatus receiving a video signal from a external device and displaying a image corresponding to the video signal, comprising:
a interface to communicate with the external device; and
a microprocessor to display a main window including a step start button to initiate a sequence of at least first and second display setting adjustment windows in which first and second display setting adjustments are made, based on a video signal inputted from the external device, and to adjust a display setting of the display based on a command inputted from the external device through the interface in correspondence to adjusting the displayed display setting adjustment windows.

23. The display apparatus according to claim 22, wherein the display further comprises:
an A/D converter to convert the video signal into a digital signal,
a scalar to fit the digitalized signal to the size of an LCD panel and transmitting the digitalized signal to a panel driving part operating the LCD panel;
a backlight; and
a power supply to supply power according to the microprocessor.

24. The display apparatus according to claim 23, wherein the external device comprises a computer including:
a graphic controller connected to the interface; and
a stored display setting program to provide the main window, to issue the command; wherein
the display setting program transmits the command and a programming signal to provide the main window to the graphic controller, which converts the programming signal into a video signal, and the graphic controller transmits the converted video signal and the command to the display apparatus through the interface.

25. The display apparatus according to claim 24, wherein the microprocessor controls the A/D converter, the scalar, and the panel driving part according to the command from the graphic controller.

26. The display apparatus according to claim 25, wherein when a user selects an item with an input unit, the display setting program issues a corresponding command to the graphic controller to adjust a corresponding display setting.

27. The display apparatus according to claim 22, wherein the interface employs a Display Data Channel Common Interface (DDC-CI) including a signal line and signal sequence such that the external device reads data from the display apparatus through the DDC-CI and the command from the display setting program is transmitted to the display through the DDC-CI.

28. The display apparatus according to claim 22, wherein the interface employs a Universal Serial Bus (USB).

29. A machine readable storage controlling a display apparatus to change a display setting of a picture area, which communicates with an external device, according to a method, the method comprising:
displaying a main window including a step start button to initiate a sequence of at least first and second display setting adjustment windows in which first and second display setting adjustments are made;
sequentially displaying the display setting adjustment windows corresponding to a selection of the step start button;
adjusting the display setting through the displayed display setting adjustment windows;
issuing a command from the external device in correspondence to adjusting the displayed display setting adjustment windows; and
setting the display setting in correspondence to the command.

30. The machine readable storage according to claim 29, wherein the main window includes a menu button to separately adjust the display settings.
